(19) United States
(12) Patent Application Publication
(10) Pub. No.: US 2017/0217537 A1
(43) Pub. Date: Aug. 3, 2017

(54) BICYCLE DRIVING DEVICE

(71) Applicant: Shimano Inc., Osaka (JP)

(72) Inventor: Takashi YAMAMOTO, Osaka (JP)

(21) Appl. No.: 15/391,781

(22) Filed: Dec. 27, 2016

(30) Foreign Application Priority Data
Jan. 29, 2016 (JP) 2016-016435

(51) Int. Cl. B62M 6/50; B62M 11/14; B62M 11/06; B62M 6/55

(52) U.S. Cl. CPC B62M 6/50; B62M 6/55; B62M 11/145; B62M 11/06

(57) ABSTRACT

A bicycle driving device allows control to be executed in accordance with the riding conditions. The bicycle driving device includes a planetary mechanism, a first motor, a second motor, and an output part. The planetary mechanism includes an input body to which rotation of a crankshaft is inputted, an output body that rotates when the input body rotates, and a transmission body that transmits rotation of the input body to the output body. The first motor is configured to rotate the input body or the output body. The second motor is configured to rotate the transmission body. The output part includes a hole through which the crankshaft extends. The output part is rotatable about the axis of the crankshaft, and rotation of the output body is transmitted to the output part.

### CROSS-REFERENCE TO RELATED APPLICATIONS

This application claims priority to Japanese Patent Application No. 2016-016435, filed on Jan. 29, 2016. The entire disclosure of Japanese Patent Application No. 2016-016435 is hereby incorporated herein by reference.

### BACKGROUND

Field of the Invention

The present disclosure generally relates to a bicycle driving device.

Background Information

Japanese Laid-Open Patent Publication No. 10-203466 describes an example of a bicycle driving device that includes a planetary mechanism, which changes the speed of the rotational input from a crankshaft, and a motor, which controls the rotation of a transmission body of the planetary mechanism. The bicycle driving device controls the rotation of the transmission body of the planetary mechanism with the motor to transmit torque to the planetary mechanism and change the gear ratio of the planetary mechanism in a stepless manner.

The bicycle driving device uses the same motor to change the gear ratio of the planetary mechanism and transmit torque to the planetary mechanism. Thus, the gear ratio and the torque cannot be separately changed. It is desirable that the bicycle driving device be able to execute control that is in accordance with the riding conditions and the like.

### SUMMARY

One object of the subject matter of the present disclosure to provide a bicycle driving device that allows control to be executed in accordance with the riding conditions.

A first aspect of the subject matter of the present disclosure is a bicycle driving device including a planetary mechanism, a first motor, a second motor and an output part. The planetary mechanism includes an input body to which rotation of a crankshaft is inputted, an output body that rotates when the input body rotates, and a transmission body that transmits rotation of the input body to the output body. The first motor is configured to rotate one of the input body and the output body. The second motor is configured to rotate the transmission body. The output part includes a hole through which the crankshaft extends. The output part is rotatable about an axis of the crankshaft, and rotation of the output body is transmitted to the output part.

One example of the bicycle driving device further includes a speed increasing mechanism configured to increase the rotation of the crankshaft in speed and transmits the rotation to the input body.

In one example of the bicycle driving device, the speed increasing mechanism includes a first gear arranged on the crankshaft and rotated integrally with the crankshaft, and a second gear arranged on the input body, rotated integrally with the input body, and engaged with the first gear.

One example of the bicycle driving device further includes a speed reduction mechanism configured to reduce the rotation of the output body in speed and transmits the rotation to the output part.

In one example of the bicycle driving device, the speed reduction mechanism includes a third gear arranged on the output body, and a fourth gear arranged on the output part and engaged with the third gear.

In one example of the bicycle driving device, a speed increasing ratio of the speed increasing mechanism and a speed reduction ratio of the speed reduction mechanism are selected so that the crankshaft and the output part rotate at different speeds when the second motor is not operating.

In one example of the bicycle driving device, the second motor includes an output shaft that is coaxial with the input body.

In one example of the bicycle driving device, the second motor and the output part are located at opposite sides of the planetary mechanism in an axial direction of the crankshaft.

One example of the bicycle driving device further includes a switching mechanism configured to permit relative rotation of the crankshaft and the output part when the crankshaft rotates in a first direction and integrally rotates the crankshaft and the output part when the crankshaft rotates in a second direction.

In one example of the bicycle driving device, at least a portion of the switching mechanism is located between the crankshaft and the output part.

In one example of the bicycle driving device, the switching mechanism includes a roller, which is located between an outer circumferential portion of the crankshaft and an inner circumferential portion of the output part, and a groove, which is formed in one of the outer circumferential portion of the crankshaft and the inner circumferential portion of the output part. The groove has a depth that increases toward the second direction.

In one example of the bicycle driving device, the crankshaft includes a crankshaft body and a support arranged on the crankshaft body and rotated integrally with the crankshaft body. The support has a larger diameter than the crankshaft body, the support is configured to contact the roller, and the roller is arranged on an outer circumferential portion of the support.

In one example of the bicycle driving device, the outer circumferential portion of the support includes the groove.

One example of the bicycle driving device further includes a housing accommodating the planetary mechanism, the first motor, the second motor, and the output part.

In one example of the bicycle driving device, the switching mechanism further includes a first biasing member, a second biasing member, and a holder that holds the roller. The first biasing member biases the roller in the second direction with the holder. The second biasing member is slidably supported on the housing, and the second biasing member moves the roller relative to the crankshaft in the first direction with the holder when the crankshaft rotates in the second direction.

In one example of the bicycle driving device, the input body includes a ring gear. The output body includes a planetary gear and a carrier, and the transmission body includes a sun gear.

One example of the bicycle driving device further includes a first one-way clutch located between the ring gear and the carrier. The first one-way clutch stops transmitting rotation of the ring gear to the carrier when the crankshaft is rotated in the second direction.

In one example of the bicycle driving device, the input body includes a planetary gear and a carrier. The output body includes a ring gear, and the transmission body includes a sun gear.

One example of the bicycle driving device further includes a second one-way clutch that permits rotation of an output shaft of the second motor in one direction and restricts rotation of the output shaft in another direction.

One example of the bicycle driving device further includes the crankshaft.

One example of the bicycle driving device further includes a controller programmed to control the first motor and the second motor.

The bicycle driving device according to the present disclosure allows control to be executed in accordance with the riding conditions.

### BRIEF DESCRIPTION OF THE DRAWINGS

FIG. 1 is a side elevational view of a drivetrain of a motor assisted bicycle that is equipped with a bicycle driving device in accordance with a first embodiment.

FIG. 2 is a cross-sectional view of the bicycle driving device taken along section line 2-2 in FIG. 1.

FIG. 3 is a schematic diagram of a switching mechanism of the bicycle driving device shown in FIG. 2 when a crankshaft is rotated in a first direction.

FIG. 4 is a schematic diagram of the switching mechanism of the bicycle driving device shown in FIG. 2 when the crankshaft is rotated in a second direction.

FIG. 5 is a cross-sectional view of a bicycle driving device in accordance with a second embodiment.

FIG. 6 is a cross-sectional view of a bicycle driving device in accordance with a third embodiment.

FIG. 7 is a plan view of a switching mechanism of a bicycle driving device in accordance with a fourth embodiment.

FIG. 8 is an enlarged partial side view of a portion of the switching mechanism shown in FIG. 7.

FIG. 9 is a partial side view of the switching mechanism shown in FIG. 8 when the crankshaft is rotated in the first direction.

FIG. 10 is a partial side view of the switching mechanism shown in FIG. 8 when the crankshaft is rotated in the second direction.

### DESCRIPTION OF THE EMBODIMENTS

Selected embodiments of a bicycle drive unit will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

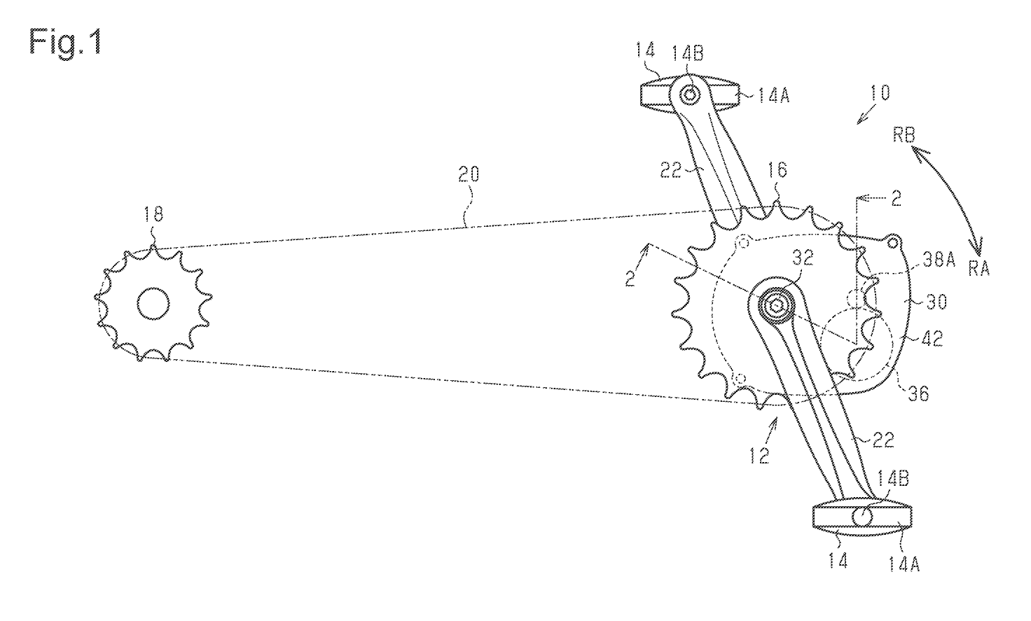

Referring initially to FIG. 1, a side elevational view of a motor assisted bicycle (i.e., a pedelec) 10 is illustrated that is equipped with a bicycle driving device 30 in accordance with a first embodiment. The motor assisted bicycle 10 will hereafter be referred to as “the bicycle 10”. In one example, the bicycle 10 includes a crank 12, two pedals 14, a front sprocket 16, a rear sprocket 18 and a chain 20. The crank 12 includes two crank arms 22 and a crankshaft 32 of the bicycle driving device 30.

The two crank arms 22 are respectively coupled to the two ends of the crankshaft 32 so as to rotate integrally with the crankshaft 32. Each of the pedals 14 includes a pedal body 14A and a pedal shaft 14B. The pedal shaft 14B is coupled to the corresponding one of the crank arms 22 so as to rotate integrally with the corresponding one of the crank arms 22. The pedal body 14A is supported by the pedal shaft 14B so as to be rotatable relative to the pedal shaft 14B.

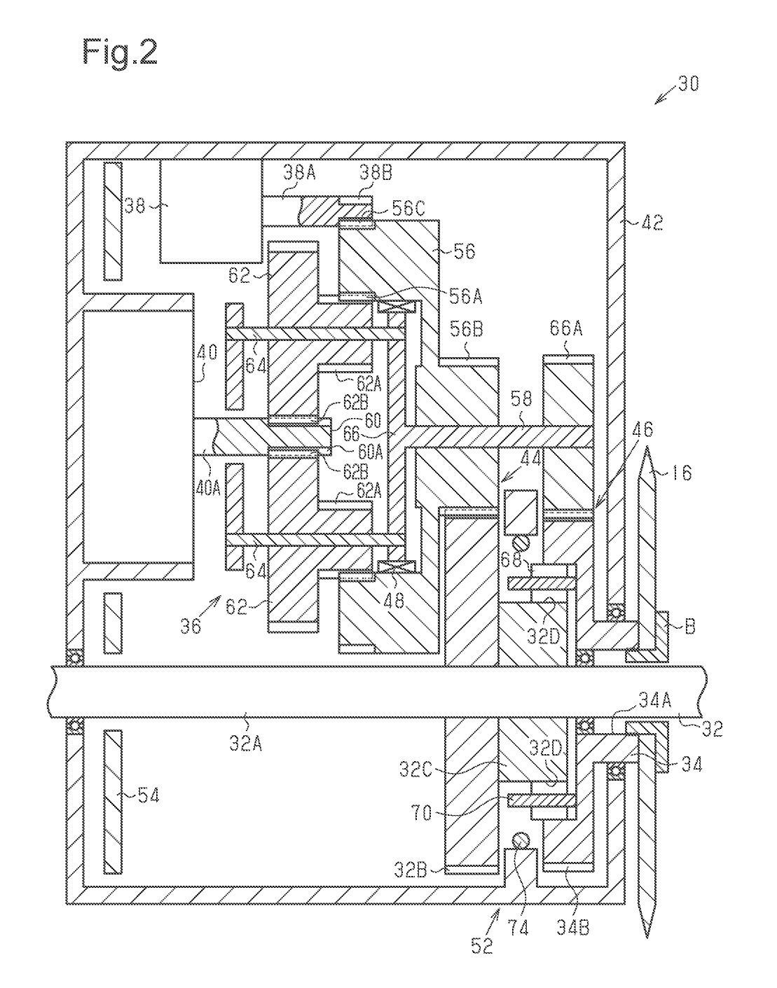

The front sprocket 16 is coupled to an output part 34 of the bicycle driving device 30 (refer to FIG. 2). The rear sprocket 18 is coupled to a drive wheel (not shown). The chain 20 runs around the front sprocket 16 and the rear sprocket 18. In one example, the drive wheel is a rear wheel. The rear sprocket 18 is coupled to a hub that includes a coaster brake.

As shown in FIG. 2, in addition to the output part 34, the bicycle driving device 30 further includes a planetary mechanism 36, a first motor 38 and a second motor 40 a. In one example, in addition to the crankshaft 32, the bicycle driving device 30 further includes a housing 42, a speed increasing mechanism 44, a speed reduction mechanism 46, a first one-way clutch 48, a switching mechanism 52 and a controller 54. The bicycle driving device 30 assists human power that is input to the crank 12. The crankshaft 32 is supported by the housing 42 so as to be rotatable relative to the housing 42. The crankshaft 32 is rotatable relative to the housing 42 in a forward rotation direction in which the bicycle 10 moves forward (hereafter referred to as “the first direction RA”) and a direction opposite to the forward rotation direction (hereafter referred to as “the second direction RB”). The crankshaft 32 can be solid or hollow.

The planetary mechanism 36, the first motor 38, the second motor 40, the output part 34, the crankshaft 32, the speed increasing mechanism 44, the speed reduction mechanism 46, the first one-way clutch 48, the switching mechanism 52 and the controller 54 are accommodated in the housing 42. It is preferred that the controller 54 be arranged inside the housing 42. However, the controller 54 can be arranged outside the housing 42, for example, on the frame of the bicycle 10.

The crankshaft 32 includes a crankshaft body 32A and a support 32C. The two ends of the crankshaft 32 project out of the housing 42. The support 32C is located in the housing 42. The support 32C is arranged on the crankshaft body 32A and rotated integrally with the crankshaft body 32A. The support 32C can be formed integrally with the crankshaft body 32A. Alternatively, the support 32C can be formed separately from the crankshaft body 32A and be fixed in a non-rotatable manner to the crankshaft body 32A. The support 32C has a larger outer diameter than the crankshaft body 32A.

The output part 34 includes a bore 34A. The crankshaft 32 extends through the bore 34A. The output part 34 is rotatable about the axis of the crankshaft 32. Rotation of an output body 58 of the planetary mechanism 36 is transmitted to the output part 34. One end of the output part 34 projects out of the housing 42. The output part 34 is rotatably supported by the housing 42 with a bearing 33C. The portion of the output part 34 projecting out of the housing 42 is coupled by a bolt B to the front sprocket 16. The bolt B is fastened to the bore 34A so that the front sprocket 16 is fixed between the output part 34 and the bolt B. Splines can be formed in the outer circumferential portion of the output part 34. For example, the front sprocket 16 can be engaged with the splines to restrict rotation of the front sprocket 16 relative to the crankshaft 32. Further, a step can be formed in the outer circumferential portion of the crankshaft 32 to cooperate with the bolt B and restrict axial movement of the front sprocket 16. The front sprocket 16 and the bolt B can be coupled to the outer circumferential portion of the output part 34. The front sprocket 16 can be a pulley.

The planetary mechanism 36 is a planetary gear mechanism. The planetary mechanism 36 includes an input body 56, a transmission body 60 and the output body 58. The planetary mechanism 36 is located at a radially outer side of the crankshaft 32. The axis of the planetary mechanism 36 is parallel to the axis of the crankshaft 32. As shown in FIG. 1, it is preferred that the planetary mechanism 36 be farther from the rear sprocket 18 and the drive wheel (not shown) than the crankshaft 32.

Rotation of the crankshaft 32 is transmitted by the speed increasing mechanism 44 to the planetary mechanism 36. The speed increasing mechanism 44 includes a first gear 32B and a second gear 56B. The second gear 56B is engaged with the first gear 32B. The first gear 32B is arranged on the crankshaft body 32A and rotated integrally with the crankshaft body 32A. The first gear 32B and the second gear 56B are located in the housing 42. The first gear 32B has a larger outer diameter than the crankshaft body 32A. The first gear 32B and the support 32C are located next to each other in the axial direction of the crankshaft 32. The support 32C is closer to the front sprocket 16 than the first gear 32B. The first gear 32B has a larger outer diameter than the support 32C. The first gear 32B and the support 32C can be formed integrally with each other. Alternatively, the first gear 32B and the support 32C can be separate from each other and be separately coupled to the crankshaft 32. Rotational input to the crankshaft 32 from the pedals 14 (referring to FIG. 1) is transmitted by the first gear 32B to the input body 56 of the planetary mechanism 36. The second gear 56B has fewer teeth than the first gear 32B.

Referring to FIG. 2, the rotation of the crankshaft 32 is input to the input body 56. The input body 56 includes a ring gear 56A. The input body 56 is an annular body. Preferably, the input body 56 includes the second gear 56B of the speed increasing mechanism 44 and a first motor gear 56C. The ring gear 56A is formed by the inner circumferential portion of the input body 56. Preferably, the ring gear 56A is formed integrally with the input body 56. The second gear 56B is formed by the outer circumferential portion of the input body 56. The second gear 56B is rotated integrally with the input body 56 and engaged with the first gear 32B. Preferably, the second gear 56B is formed integrally with the input body 56. The first motor gear 56C is formed by the outer circumferential portion of the input body 56 at a location that differs from the second gear 56B. Preferably, the first motor gear 56C is formed integrally with the input body 56. The input body 56 has a smaller diameter at the portion where the second gear 56B is located than the portion where the first motor gear 56C is located.

The transmission body 60 transmits the rotation of the input body 56 to the output body 58. The transmission body 60 includes a sun gear 60A. The sun gear 60A can be formed integrally with an output shaft 40A of the second motor 40. In a further example, the sun gear 60A can be formed separately from the output shaft 40A and coupled to the output shaft 40A.

The output body 58 rotates when the input body 56 rotates. The output body 58 includes a plurality of planetary gears 62, a plurality of planetary pins 64, and a carrier 66. The planetary gears 62 are arranged between the sun gear 60A of the transmission body 60 and the ring gear 56A. Each of the planetary gears 62 includes a small diameter portion 62A and a large diameter portion 62B. The planetary gears 62 are each a stepped planetary gear. The teeth of the small diameter portion engage the teeth of the ring gear 56A. The teeth of the large diameter portion 62B engage the teeth of the sun gear 60A.

The planetary pins 64 respectively extend through the planetary gears 62 in the axial direction. The two axial ends of each of the planetary pins 64 are supported by the carrier 66. The planetary pins 64 are rotated integrally with the carrier 66. Each of the planetary gears 62 is supported by the corresponding one of the planetary pins 64 in a manner rotatable relative to the planetary pins 64. Further, each of the planetary gears 62 is coaxial with the corresponding one of the planetary pins 64. The planetary pins 64 can be rotatably supported by the carrier 66 and fixed to the corresponding one of the planetary gears 62.

The speed reduction mechanism 46 reduces the rotational speed of the output body 58 and transmits the rotation to the output part 34. The speed reduction mechanism 46 includes a third gear 66A and a fourth gear 34B. The third gear 66A is arranged on the carrier 66. The third gear 66A is arranged on the outer peripheral portion of the carrier 66 at the side that is closer to the front sprocket 16. The third gear 66A is engaged with the fourth gear 34B that is formed by the outer circumferential portion of the output part 34. The rotation of the carrier 66 is output by the speed reduction mechanism 46 to the output part 34. The fourth gear 34B on the output part 34 engages the third gear 66A. The fourth gear 34B has more teeth than the third gear 66A.

The speed increasing ratio of the speed increasing mechanism 44 and the speed reduction ratio of the speed reduction mechanism 46 are selected so that the rotational speed of the crankshaft 32 differs from the rotational speed of the output part 34 when the second motor 40 is not operating. More specifically, the number of teeth of the first gear 32B differs from the number of teeth of the fourth gear 34B. The first gear 32B can have more teeth than the fourth gear 34B or fewer teeth than the fourth gear 34B. Preferably, the difference in the number of teeth is small between the first gear 32B and the fourth gear 34B. The speed increasing ratio of the speed increasing mechanism 44 corresponds to the number of teeth of the first gear 32B relative to the number of teeth of the second gear 56B. The speed reduction ratio of the speed reduction mechanism 46 corresponds to the number of teeth of the third gear 66A relative to the number of teeth of the fourth gear 34B.

The first motor 38 is supported by the housing 42. The first motor 38 is located at the outer side of the crankshaft 32 in the radial direction of the crankshaft 32. The first motor 38 is configured to rotate the input body 56. The first motor 38 has an output shaft 38A including a gear 38B that is engaged with the first motor gear 56C of the input body 56. The gear 38B has fewer teeth than the first motor gear 56C. Thus, the rotation produced by the first motor 38 is reduced in speed and increased in torque when transmitted to the input body 56.

The first one-way clutch 48 is located between the ring gear 56A and the carrier 66. In one example, the first one-way clutch 48 is formed by a roller clutch or a pawl clutch. The first one-way clutch 48 does not transmit the rotation of the ring gear 56A to the carrier 66 when the crankshaft 32 rotates in the second direction RB. The first one-way clutch 48 permits relative rotation of the carrier 66 and the ring gear 56A if the crankshaft 32 rotates in the first direction RA when the rotational speed of the carrier 66 is higher than the rotational speed of the ring gear 56A. The first one-way clutch 48 rotates the carrier 66 and the ring gear 56A integrally with each other if the crankshaft 32 rotates in the first direction RA when the rotational speed of the carrier 66 is less than or equal to the rotational speed of the ring gear 56A.

The second motor 40 is supported by the housing 42. The second motor 40 and the output part 34 are arranged at opposite sides of the planetary mechanism 36 in the axial direction of the crankshaft 32. The second motor 40 includes an output shaft 40A that is coaxial with the input body 56. The second motor 40 is configured to rotate the transmission body 60.

When the output shaft 40A of the second motor 40 is rotated relative to the housing 42 in one direction, the output body 58 is rotated at a higher speed than the output shaft 40A of the second motor 40 and the sun gear 60A. If the rotational speed of the output body 58 does not exceed the rotational speed of the input body 56 when the crankshaft 32 is rotating in the first direction RA, the rotation of the input body 56 is transmitted by the first one-way clutch 48 to the output body 58. Further, the planetary mechanism 36 does not function to change speeds. If the rotational speed of the output body 58 exceeds the rotational speed of the input body 56 when the crankshaft 32 is rotating in the first direction RA, the rotation of the input body 56 is transmitted by the transmission body 60 to the output body 58. Further, the rotational speed of the transmission body 60 changes in accordance with the rotational speed of the second motor 40.

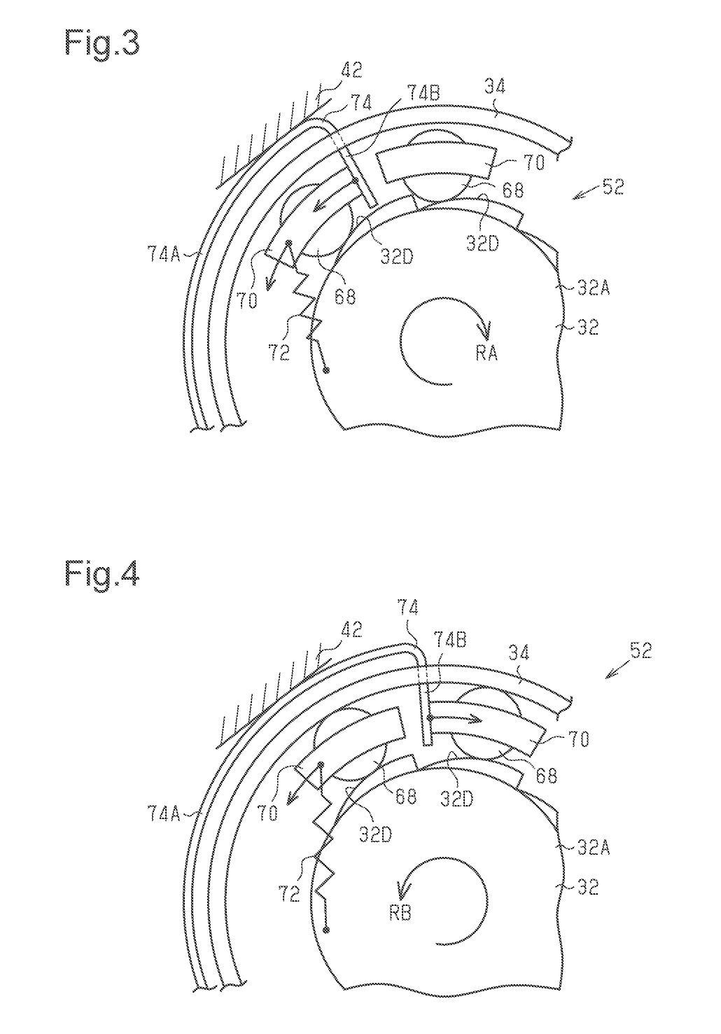

The structure of the switching mechanism 52 will now be described with reference to FIGS. 2 to 4. FIGS. 3 and 4 are schematic views in which some of the members of the switching mechanism 52 are projected onto the same plane that is orthogonal to the crankshaft 32.

As shown in FIG. 2, at least a portion of the switching mechanism 52 is located between the crankshaft 32 and the output part 34. The switching mechanism 52 is located closer to the front sprocket 16 than the first gear 32B of the speed increasing mechanism 44. The switching mechanism 52 permits relative rotation of the crankshaft 32 and the output part 34 when the crankshaft 32 rotates in the first direction RA. The switching mechanism 52 rotates the crankshaft 32 and the output part 34 integrally with each other when the crankshaft 32 rotates in the second direction RB.

As shown in FIG. 3, the switching mechanism 52 includes a plurality of rollers 68, a holder 70, a first biasing member 72, a second biasing member 74 and a plurality of grooves 32D. The grooves 32D are formed in the outer circumferential portion of the crankshaft 32. FIG. 3 shows only two rollers 68. However, it is preferred that there are three or more rollers 68 arranged at equal intervals in the circumferential direction of the crankshaft 32. The grooves 32D are formed in the outer circumferential portion of the support 32C on the crankshaft 32. The depth of each of the grooves 32D increases toward the second direction RB.

The rollers 68 are arranged on the outer circumferential portion of the support 32C. In detail, the rollers 68 are located between the outer circumferential portion of the crankshaft 32 and the inner circumferential portion of the output part 34. The rollers 68 are received in the grooves 32D, respectively. The support 32C of the crankshaft 32 can contact the rollers 68.

The holder 70 holds the rollers 68. The rollers 68 are held in a rotatable manner by the holder 70. The first biasing member 72 biases the rollers 68 with the holder 70 in the second direction RB. The second biasing member 74 is supported to be slidable on the housing 42. When the crankshaft 32 rotates in the second direction RB, the second biasing member 74 moves the rollers 68 with the holder 70 in the first direction RA relative to the crankshaft 32. The first biasing member 72 is formed by a spring such as a coil spring. The second biasing member 74 is formed by, for example, a slide spring. The second biasing member 74 includes an annular portion 74A and an end 74B that projects from the annular portion 74A toward the inner side in the radial direction. The annular portion 74A of the second biasing member 74 is supported by the housing 42 so as to be rotatable in the circumferential direction of the crankshaft 32. The end 74B of the second biasing member 74 is allowed to contact the holder 70.

The controller 54 includes a central processing unit (CPU) and a memory. The controller 54 further includes a circuit board on which the CPU and the memory are mounted. In one example, the memory includes a non-volatile memory and stores control programs executed by the CPU and various types of setting information. The controller 54 is electrically connected to the first motor 38 and the second motor 40. The controller 54 receives signals from various types of sensors. It is preferred that the sensors include a vehicle speed sensor that detects the vehicle speed. The controller 54 and the motors 38 and 40 are supplied with power from a battery (not shown) that is arranged on the bicycle 10.

The controller 54 is programmed to control the first motor 38 and the second motor 40. More specifically, the controller 54 controls the rotation produced by the first motor 38 and the rotation produced by the second motor 40 in accordance with at least one of the human power, the rotational speed of the crankshaft 32, and the vehicle speed. The controller 54 is programmed to control the output torque of the first motor 38 in accordance with the human power based on an assist ratio that is preset in advance. The human power is calculated from, for example, the torque of the second motor 40. The torque of the second motor 40 can be detected to estimate the human power. The controller 54 can control the first motor 38 and the second motor 40 in any one of a first mode, a second mode, a third mode, and a fourth mode. The controller 54 is programmed to drive only the first motor 38 in the first mode. The controller 54 is further programmed to drive both of the first motor 38 and the second motor 40 in the second mode. The controller 54 is further programmed to drive only the second motor 40 in the third mode. The controller 54 is further programmed to not drive any of the first motor 38 and the second motor 40 in the fourth mode. An operation unit can be used to select each mode. In the first mode and the second mode that allow for human power assistance, it is preferred that the second motor 40 be driven so that the output body 58 is rotated at a higher speed than the input body 56. The torque of the second motor 40 is proportional to the torque of the input body 56. Thus, the controller 54 can detect the torque of the second motor 40 to obtain the human power. Even when the torque of the input body 56 is generated by the first motor 38 and the human power, the controller 54 controls the torque of the first motor 38. This allows for only the human power to be obtained. The torque of the second motor 40 can be obtained by detecting the current of the second motor 40. Alternatively, the torque of the second motor 40 can be obtained from the current applied to the second motor 40 or control parameters of the controller 54 for the second motor 40. The rotational speed of the crankshaft 32 is calculated from, for example, the rotational speed of the first motor 38. The speed increasing ratio of the speed increasing mechanism 44 and the speed reduction ratio of the gear 38B and the first motor gear 56C are set in advance. This allows the controller 54 to calculate the rotational speed of the crankshaft 32 from the rotational speed of the first motor 38. The controller 54 determines the rotational speed of the first motor 38 from the current of the first motor 38 or the detection signal of an encoder provided for the first motor 38.

The sensors can include at least one of a torque sensor that detects the human power and a rotational speed sensor that detects the rotational speed of the crankshaft 32. The torque sensor is, for example, a strain gauge, a semiconductor strain gauge, or a magnetostrictive sensor. The torque sensor is coupled to the crankshaft 32 or the first gear 32B to detect the torque applied to the crankshaft 32. In another example, the torque sensor is coupled to the output part 34 to detect the torque applied to the output part 34. The rotational speed sensor is arranged in the housing 42, and includes a magnetic sensor that detects a magnet arranged on the crankshaft 32. The vehicle speed is calculated from, for example, the output of the vehicle speed sensor. It is preferred that the supply of power to the first motor 38 and the second motor 40 be stopped when the rotation of the crankshaft 32 is stopped and when the crankshaft 32 is rotated in the second direction RB. The controller 54 can control the rotation of the second motor 40 in accordance with an instruction from a gear change instruction device that is operable by the rider.

The controller 54 produces rotation with the first motor 38 to rotate the input body 56 in the forward direction. When the input body 56 is rotated in the forward rotation direction, rotation is transmitted to the output part 34 in the direction that moves forward the bicycle 10. In the present embodiment, the forward rotation direction of the input body 56 is opposite to the first direction RA of the crankshaft 32.

The controller 54 produces rotation with the second motor 40 to rotate the transmission body 60 in the forward rotation direction. As the rotational speed in the forward rotation direction transmitted to the transmission body 60 from the second motor 40 increases, the gear ratio r of the planetary mechanism 36 increases. The controller 54 can control the rotational speed of the second motor 40 to continuously vary the gear ratio r. The gear ratio r of the planetary mechanism 36 is the ratio of the speed of the rotation output from the output body 58 relative to the speed of the rotation input to the input body 56. Although the speed of the planetary mechanism 36 is variable in a stepless manner, it is preferred that the controller 54 control the rotation produced by the second motor 40 to obtain any one of predetermined gear ratios.

If the second motor 40 is not supplied with power when the crankshaft 32 is rotated in the first direction RA, the first one-way clutch 48 functions to rotate the input body 56 and the output body 58 integrally with each other. In this case, the gear ratio r of the planetary mechanism 36 is “1.” When the second motor 40 is supplied with power but the rotation produced by the second motor 40 cannot rotate the output body 58 at a higher speed than the input body 56, the gear ratio r of the planetary mechanism 36 is “1.” When the rotation produced by the second motor 40 rotates the output body 58 at a higher speed than the input body 56, the gear ratio r of the planetary mechanism 36 is greater than “1.”

The operation of the switching mechanism 52 will now be described.

When the crankshaft 32 shown in FIG. 2 is rotated in the first direction RA, the one-way clutch 48 maintains the gear ratio r of the planetary mechanism 36 at “1” or greater. If the fourth gear 34B has more teeth than the first gear 32B, the rotational speed of the crankshaft 32 is lower than the rotational speed of the output part 34 when the crankshaft 32 rotates in the first direction RA. If the fourth gear 34B has fewer teeth than the first gear 32B, the rotational speed of the crankshaft 32 is higher than the rotational speed of the output part 34 when the crankshaft 32 rotates in the first direction RA.

Referring to FIG. 3, when the crankshaft 32 rotates in the first direction RA, the first biasing member 72 and the second biasing member 74 apply force with the holder 70 to the rollers 68 in the second direction RB. When the holder 70 rotates in the first direction RA as the crankshaft 32 rotates, the second biasing member 74 restricts movement of the rollers 68 relative to the crankshaft 32 in the first direction RA. Thus, the rollers 68 are located at deep portions in the grooves 32D. This separates the rollers 68 from the output part 34 and permits relative rotation of the crankshaft 32 and the output part 34.

Referring to FIG. 4, when the crankshaft 32 rotates in the second direction RB, the second biasing member 74 applies force with the holder 70 to the rollers 68 in the first direction RA and moves the rollers 68 relative to the crankshaft 32 in the first direction RA. When the force applied by the second biasing member 74 to the rollers 68 in the first direction RA becomes greater than the force applied by the first biasing member 72 to the rollers 68 in the second direction RB, the rollers 68 are located at shallow portions in the grooves 32D. Thus, the rollers 68 come into contact with both of the output part 34 and the outer circumferential portion of the crankshaft 32 and restrict relative rotation of the crankshaft 32 and the output part 34. This rotates the output part 34 and the crankshaft 32 integrally with each other.

When the crankshaft 32 shown in FIG. 2 is rotated in the second direction RB, the controller 54 stops the second motor 40. When the controller 54 stops producing rotation with the second motor 40 and fixes the rotation shaft of the second motor 40, the gear ratio r of the planetary mechanism 36 is less than “1.” If the supply of power to the controller 54 is stopped when the second motor 40 is stopped, the rotation shaft of the second motor 40 becomes free and the planetary mechanism 36 does not function to change speeds. Thus, the rotation force of the crankshaft 32 in the second direction RB is transmitted by the rollers 68 to the output part 34 before the rotation force of the crankshaft 32 is transmitted by the planetary mechanism 36 to the output part 34. When the crankshaft 32 is rotated in the second direction RB, the output part 34 is also rotated in the second direction RB. This reverses the rotation of the rear sprocket 18 with the front sprocket 16 and the chain 20 and activates the coaster brake.

The operation and advantages of the bicycle driving device 30 will now be described.

The bicycle driving device 30 includes the first motor 38 and the second motor 40. Thus, changes in the gear ratio r made by the second motor 40 can be separate from changes in the assist force made by the first motor 38. This allows for execution of a control that is further suitable for the riding conditions or the like.

In a conventional bicycle driving device, the planetary mechanism is arranged surrounding the entire crankshaft. This results in the distance between the crankshaft and the drive wheel being longer than that of a normal bicycle. In the bicycle driving device 30 of the present embodiment, the planetary mechanism 36 is located at the radially outer side of the crankshaft 32. Thus, the planetary mechanism 36 does not surround the crankshaft 32 like in the conventional bicycle driving device. Thus, the distance between the crankshaft 32 and the drive wheel does not have to be increased. Further, in the bicycle driving device 30, the crankshaft 32 is not inserted into the rotation shaft of the second motor 40. This allows the structure of the second motor 40 to remain simple.

If the axis of the output part 34 were to be separated from the axis of the crankshaft 32 by arranging the output at the radially outer side of the crankshaft 32, to avoid interference between the front sprocket 16 and the crankshaft 32, the distance between the output and the crankshaft 32 would have to be increased and the number of teeth on the front sprocket 16 would have to be limited. This can enlarge the bicycle driving device or result in a situation in which a front sprocket with the required number of teeth cannot be used. In this regard, the output part 34 of the bicycle driving device 30 is arranged in a rotatable manner around the axis of the crankshaft 32. This limits enlargement of the bicycle driving device 30 that would occur when using a front sprocket with the required number of teeth. Further, there is no limitation to the number of teeth on the front sprocket 16.

As the torque input to the planetary mechanism increases, the torque required to be output from the second motor increases. In the bicycle driving device 30, the speed increasing mechanism 44 increases the speed of the rotation produced by the crankshaft 32, and transmits the rotation to the planetary mechanism 36. This decreases the torque input to the planetary mechanism 36. Thus, the second motor 40 can be reduced in size.

In the bicycle driving device 30, the speed reduction mechanism 46 reduces the rotation of the output body 58 in speed, and transmits the rotation to the output part 34. This increases the torque of the output part 34 so that the torque transmitted to the front sprocket 16 and the drive wheel is not excessively small.

In the bicycle driving device 30, the speed increasing ratio of the speed increasing mechanism 44 and the speed reduction ratio of the speed reduction mechanism 46 is selected so that the rotational speed of the crankshaft 32 differs from the rotational speed of the output part 34 when the second motor 40 is not operating. Thus, the phase of gear engagement in the speed increasing mechanism 44 differs from the phase of gear engagement in the speed reduction mechanism 46. This reduces mechanical noise.

The output shaft 40A of the second motor 40 is coaxial with the input body 56. This simplifies the structure of the bicycle driving device 30 as compared to when the axis of the output shaft 40A of the second motor 40 is separated from the axis of the input body 56.

The switching mechanism 52 of the bicycle driving device 30 rotates the crankshaft 32 and the output part 34 integrally with each other when the crankshaft 32 is rotated in the second direction RB. This allows the rider of the bicycle 10 to activate the coaster brake, which is applied to the drive wheel, by rotating the crankshaft 32 in the second direction RB.

The support 32C of the bicycle driving device 30 has a larger diameter than the crankshaft body 32A. This reduces the torque applied to the switching mechanism 52 by the output part 34. Thus, there is no need to enlarge the switching mechanism 52 for reinforcement purposes.

The bicycle driving device 30 includes the first one-way clutch 48 between the input body 56 and the output body 58. Thus, even if the supply of power to the second motor 40 is stopped, when the crankshaft 32 is rotated in the first direction RA, the rotation of the crankshaft 32 is transmitted to the output part 34.

### Second Embodiment

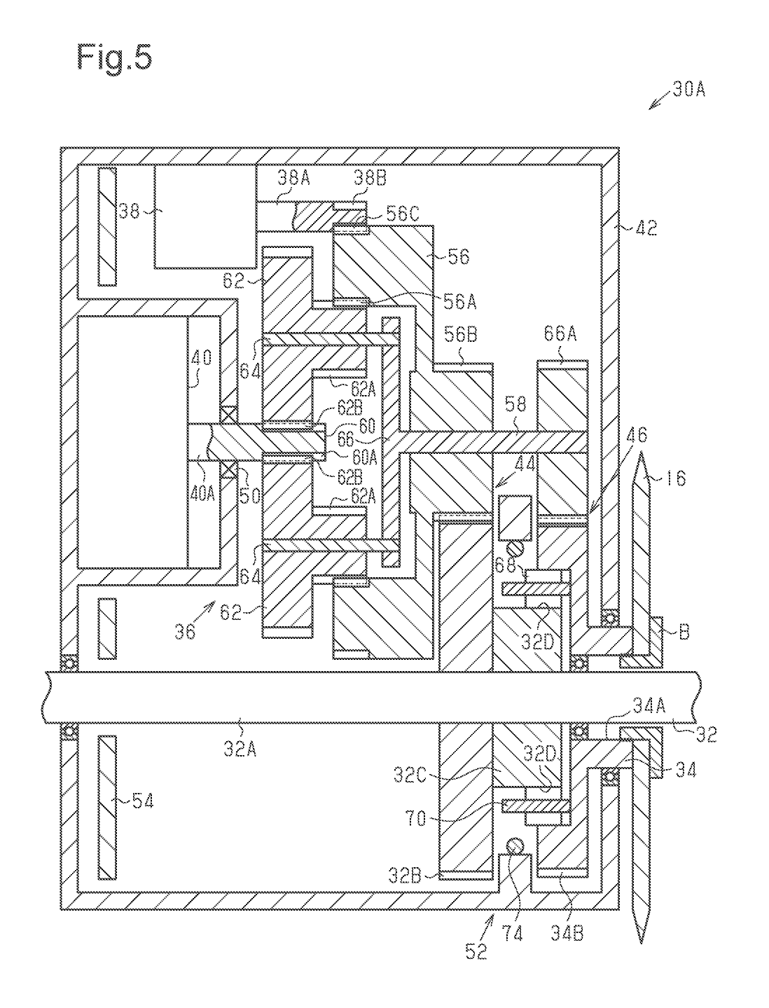

A second embodiment of a bicycle driving device 30A will now be described with reference to FIG. 5. Same reference characters are given to those components that are the same as the corresponding components of the first embodiment. Such components will not be described in detail. The bicycle driving device 30A differs from the bicycle driving device 30 of the first embodiment in that the first one-way clutch 48 is omitted and a second one-way clutch 50 is used instead.

The second one-way clutch 50 is located between the output shaft 40A of the second motor 40 and the housing 42. The second one-way clutch 50 permits rotation of the output shaft 40A of the second motor 40 in one direction and restricts rotation of the output shaft 40A in the other direction. In one example, the second one-way clutch 50 can be a roller clutch or a pawl clutch. When the output shaft 40A of the second motor 40 is rotated in one direction relative to the housing 42, the output body 58 is rotated at a higher speed than the input body 56. When the crankshaft 32 is rotated in the first direction RA, torque from the planetary gears 62 act to rotate the sun gear 60A and the output shaft 40A in the other direction. The second one-way clutch 50 functions to restrict rotation of the output shaft 40A of the second motor 40 and the sun gear 60A in the other direction relative to the housing 42 when the supply of power to the second motor 40 is stopped and when the output torque of the second motor 40 is smaller than the torque applied by the planetary gears 62. Thus, the rotation input to the planetary mechanism 36 when the second motor 40 stops is reduced in speed, before output to the output body 58, in accordance with the speed reduction ratio that is in accordance with the number of teeth of the sun gear 60A, the number of teeth of the planetary gears 62, and the number of teeth of the ring gear 56A. The second embodiment has the same advantages as the first embodiment.

### Third Embodiment

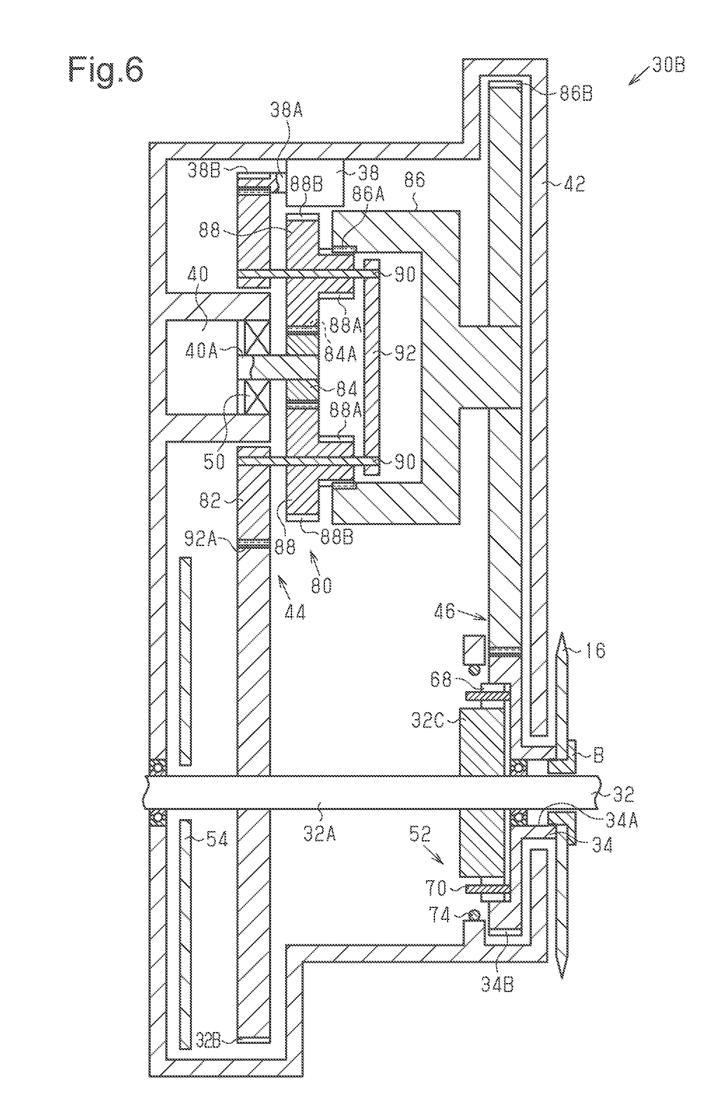

A third embodiment of a bicycle driving device 30B will now be described with reference to FIG. 6. Same reference characters are given to those components that are the same as the corresponding components of the first and second embodiments. Such components will not be described in detail. The bicycle driving device 30B differs from the bicycle driving devices 30 and 30A in the structure of the planetary mechanism, the speed increasing mechanism, and the speed reduction mechanism. Otherwise, the structure is the same as the bicycle driving device 30A.

In the present embodiment, the bicycle driving device 30B includes a planetary mechanism 80, the first motor 38, the second motor 40, and the output part 34. In one example, the bicycle driving device 30B further includes the crankshaft 32, the housing 42, the speed increasing mechanism 44, the speed reduction mechanism 46, the second one-way clutch 50, the switching mechanism 52 and the controller 54.

The planetary mechanism 80, which is a planetary gear mechanism, includes an input body 82, a transmission body 84 and an output body 86. The rotation of the crankshaft 32 is input to the input body 82.

The input body 82 includes a plurality of planetary gears 88, a plurality of planetary pins 90, and a carrier 92. Each of the planetary gears 88 includes a small diameter portion 88A and a large diameter portion 88B. The planetary gears 88 are each a stepped planetary gear. The teeth of the small diameter portion 88A engage the teeth of a ring gear 86A of the output body 86. The teeth of the large diameter portion 88B engage the teeth of a sun gear 84A of the transmission body 84. A second gear 92A is formed by the outer circumferential portion of the carrier 92. The speed increasing mechanism 44 includes the first gear 32B and the second gear 92A. One portion of the second gear 92A engages the first gear 32B, and another portion of the second gear 92A engages the gear 38B of the first motor 38.

The transmission body 84 transmits the rotation of the input body 82 to the output body 86. The transmission body 84 includes a sun gear 84A.

The output body 86 rotates when the input body 82 rotates. The output body 86 includes the ring gear 86A. The ring gear 86A is formed by the inner circumferential portion of the output body 86. The speed reduction mechanism 46 includes a third gear 86B and a fourth gear 34B. The third gear 86B is formed by the outer circumferential portion of the output body 86. The speed increasing ratio of the speed increasing mechanism 44 and the speed reduction ratio of the speed reduction mechanism 46 are set so that the rotational speed of the crankshaft 32 is close to the rotational speed of the output part 34 if the crankshaft 32 is rotated in the first direction RA when the second motor 40 is stopped.

The first motor 38 is configured to rotate the input body 82. The gear 38B has fewer teeth than the second gear 92A. Thus, the rotation produced by the first motor 38 is reduced in speed and increased in torque when transmitted to the input body 82.

The second one-way clutch 50 permits rotation of the output shaft 40A of the second motor 40 in one direction and restricts rotation of the output shaft 40A in the other direction. When the output shaft 40A of the second motor 40 is rotated in one direction relative to the housing 42, the output body 86 is rotated at a higher speed than the input body 82. When the crankshaft 32 is rotated in the first direction RA, torque from the planetary gears 88 act to rotate the sun gear 84A and the output shaft 40A in the other direction. The second one-way clutch 50 functions to restrict rotation of the output shaft 40A of the second motor 40 and the sun gear 84A in the other direction relative to the housing 42 when the supply of power to the second motor 40 is stopped and when the output torque of the second motor 40 is smaller than the torque applied by the planetary gears 88. Thus, the rotation input to the planetary mechanism 80 when the second motor 40 stops is increased in speed, before output to the output body 86, in accordance with the speed increasing ratio that is in accordance with the number of teeth of the sun gear 84A, the number of teeth of the planetary gears 88, and the number of teeth of the ring gear 86A. The gear ratio r of the planetary mechanism 80 is always greater than “1.” The third embodiment has the same advantages as the first embodiment.

### Fourth Embodiment

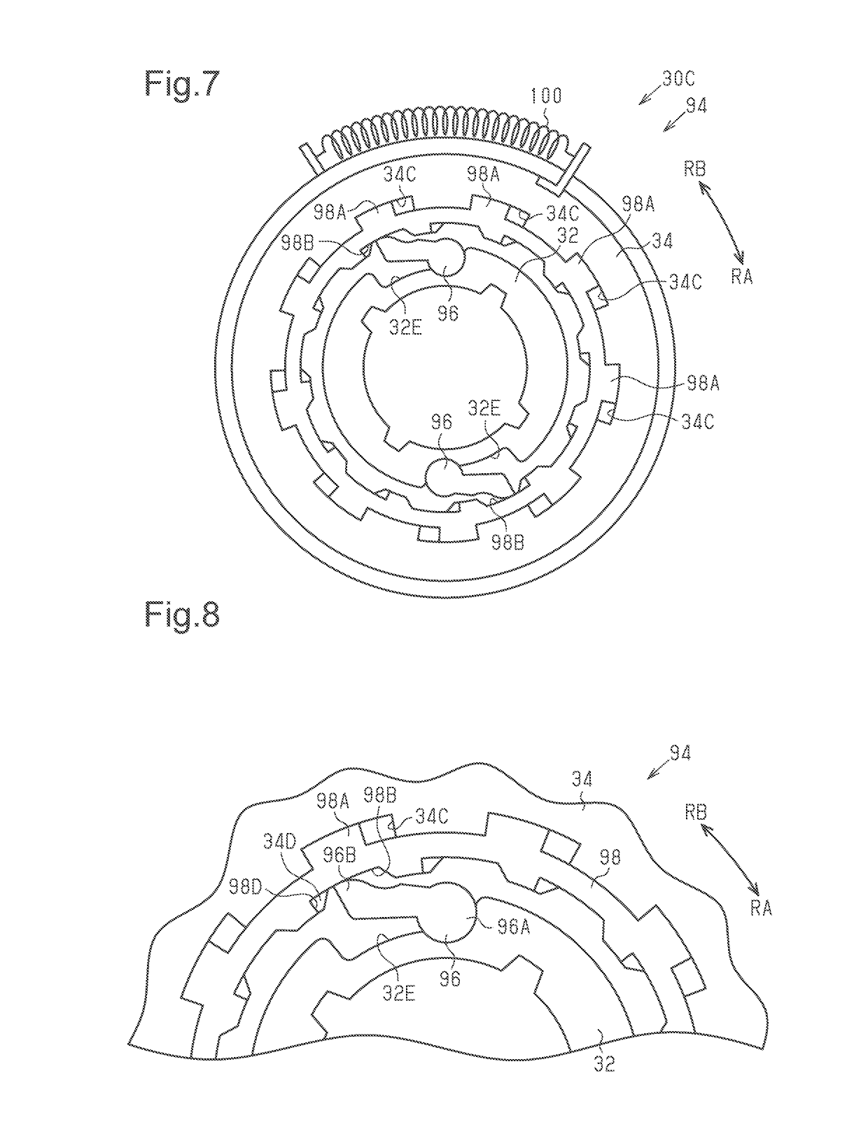

A fourth embodiment of a bicycle driving device 30C will now be described with reference to FIGS. 7 to 10. Same reference characters are given to those components that are the same as the corresponding components of the first embodiment. Such components will not be described in detail. In the present embodiment, the bicycle driving device 30C uses a switching mechanism 94, which is shown in FIG. 7, instead of the switching mechanism 52. Otherwise, the structure is the same as the bicycle driving devices 30.

At least a portion of the switching mechanism 94 is located between the outer circumference of the crankshaft 32 and the inner circumference of the output part 34. The switching mechanism 94 includes a plurality of pawls 96, a ring 98, and a third biasing member 100. Each of the pawls 96 includes a basal portion 96A and a distal portion 96B. The basal portion 96A is arranged in a recess 32E that is located in the outer circumferential portion of the crankshaft 32. The distal portion 96B can be projected out of the recess 32E. A biasing member (not shown) applies force to the pawls 96 that project the distal portions 96B out of the recesses 32E. The pawls 96 are opposed to the inner circumferential portion of the ring 98.

The ring 98 is arranged on the inner circumferential portion of the output part 34. The ring 98 is formed integrally with the front sprocket 16. In a further example, the ring 98 is formed separately from the front sprocket 16 and coupled in a non-rotatable manner to the front sprocket 16. The outer circumferential portion of the ring 98 includes a plurality of projections 98A. The projections 98A are arranged next to one another in the circumferential direction. The projections 98A are respectively fitted into recesses 34C in the inner circumferential portion of the output part 34. Each of the recesses 34C is longer in the circumferential direction than each projection 98A. Thus, each of the projections 98A is movable in the corresponding one of the recesses 34C. This allows the ring 98 to be rotated relative to the output part 34 over a predetermined angle.

The inner circumferential portion of the ring 98 includes recesses 98B. The recesses 98B are arranged next to one another in the circumferential direction. In each of the recesses 98B, an end surface in the first direction RA is sloped so that the pawl 96 does not get caught, and an end surface 98D in the second direction RB extends in the radial direction of the ring 98.

The third biasing member 100 is arranged on the outer circumferential portion of the output part 34. The third biasing member 100 is connected to the output part 34 and the ring 98. Further, the third biasing member 100 applies force in the second direction RB to the ring 98 relative to the output part 34.

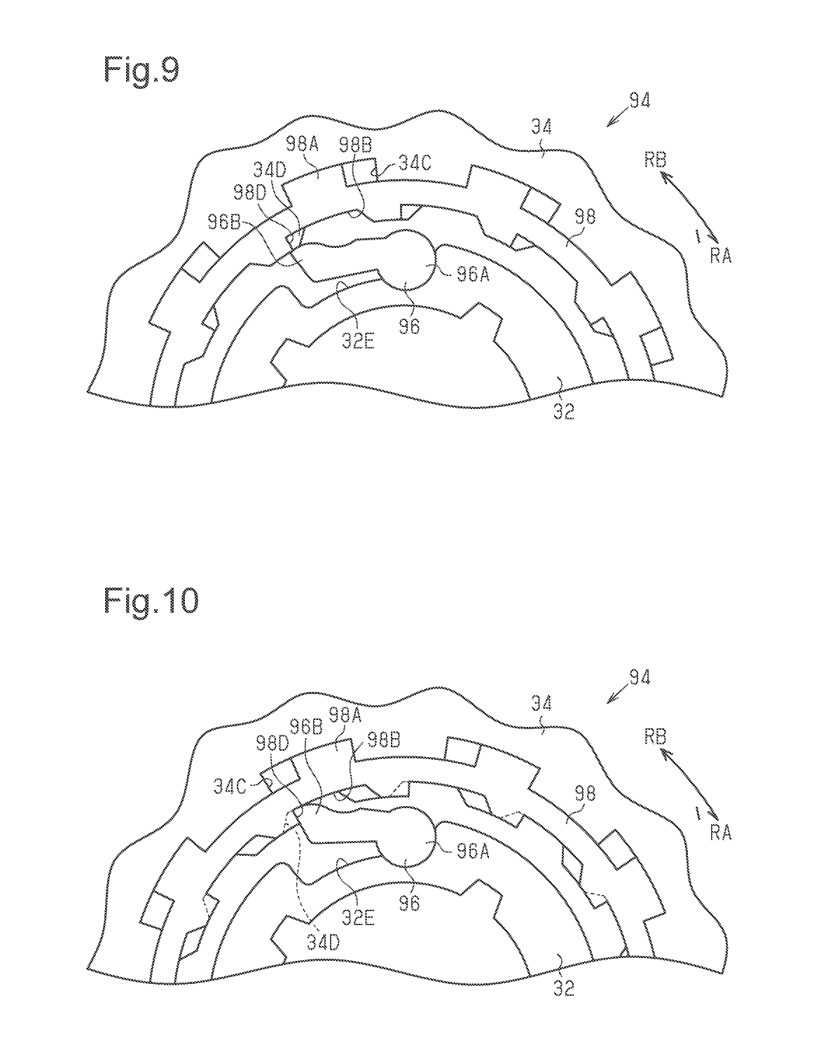

When the crankshaft 32 rotates in the first direction RA, the output part 34 rotates in the first direction RA. Thus, the end surface of each of the recesses 34C in the first direction RA contacts the end surface of the corresponding one of the projections 98A of the ring 98 in the second direction RB. This rotates the output part 34 and the ring 98 at the same speed in the first direction RA. Referring to FIG. 8, in each of the recesses 98B of the ring 98, a protrusion 34D of the output part 34 protrudes from the end surface 98D in the first direction RA. The protrusion 34D includes a sloped surface that is sloped so that the pawl 96 does not get caught. When the output part 34 rotates in the first direction RA at a higher speed than the crankshaft 32 and the distal portions 96B of the pawls 96 are received in the corresponding recesses 98B, the output part 34 rotates in the first direction RA while the sloped surfaces of the protrusions 34D lowers the distal portions 96B of the pawls toward the crankshaft 32 in the first direction RA as shown in FIG. 9.

When the crankshaft 32 shown in FIG. 2 rotates in the second direction RB, as long as the rotation shaft of the second motor 40 is not rotating under the control of the controller 54, the rotation force input from the crankshaft 32 is transmitted by the planetary mechanism 36 to the output part 34. This rotates the output part 34 in the second direction RB. Referring to FIG. 8, when the distal portions 96B of the pawls 96 are located at positions opposed to the corresponding recesses 98B, the distal portions 96b of the pawls 96 are received in the recesses 98B. In this state, when the crankshaft 32 further rotates relative to the ring 98 in the second direction RB and the force that rotates the output part 34 shown in FIG. 7 in the second direction RB exceeds the force applied to the output part 34 from the third biasing member 100, the output part 34 moves relative to the ring 98 in the second direction RB. Further, the end surface in the first direction RA of each of the projections 98A of the ring 98 contacts the end surface in the second direction RB of the corresponding one of the recesses 34C. Since the protrusions 34D extend away from the end surfaces 98D of the recesses 98B in the second direction RB, the distal portions 96B of the pawls 96 engage the end surfaces 98D of the recesses as shown in FIG. 10. When the crankshaft 32 further rotates in the second direction RB from this state, the crankshaft 32 further rotates the ring 98 in the second direction with the pawls 96. When the crankshaft 32 is rotated in the second direction RB, the ring 98 and the output part 34 are rotated at the same speed as the crankshaft 32. The fourth embodiment has the same advantages as the first embodiment.

### Modified Examples

The present disclosure is not limited to the foregoing embodiments and various changes and modifications of its components can be made without departing from the scope of the present disclosure. Also, the components disclosed in the embodiments can be assembled in any combination for embodying the present disclosure. For example, some of the components can be omitted from all components disclosed in the embodiments. Further, components in different embodiments can be appropriately combined.

The switching mechanism 52 of the first embodiment can include grooves that receive the rollers 68 in the inner circumferential portion of the output part 34 instead of the outer circumferential portion of the support 32C.

The first motor 38 of each embodiment can be configured to be able to rotate the output bodies 58 and 86 instead of the input bodies 56 and 82. For example, gears can be formed by the outer circumferential portions of the output bodies 58 and 86 and be engaged with the gear 38B of the output shaft 38A of the first motor 38.

The bicycle driving device of each embodiment can further include a speed reduction mechanism that reduces the speed of the rotation produced by the first motor 38 and transmits the rotation to the input body 56.

The speed increasing mechanism 44 of each embodiment can further include a gear located between the first gear 32B and the second gear 56B or 92A to increase the rotation of the first gear 32B in speed and transmit the rotation to the second gear 56B or 92A. Further, a belt or chain that runs around the crankshaft 32 and the input body 56 or 82 can be used as the speed increasing mechanism 44. A speed increasing mechanism of any structure can be employed as long as the rotation of the crankshaft 32 can be increased in speed and transmitted to the input body 56 or 82.

The speed increasing mechanism 44 in each of the above embodiments can be a speed reduction mechanism or a uniform speed mechanism. In this case, for example, the first gear 32B has fewer teeth than the gears 56B and 92A.

The speed reduction mechanism 46 in each of the above embodiments can further include a gear between the third gear 66A or 86B and the fourth gear 34B to increase the rotation of the third gear 66A or 86B in speed and transmit the rotation to the further gear. Further, a belt or chain that runs around the output body 58 or 86 and the output part 34 can be used as the speed reduction mechanism 46. A speed reduction mechanism of any structure can be employed as long as the rotation of the output body 58 or 86 can be reduced in speed and transmitted to the output part 34. When using a belt or a chain as the speed increasing mechanism 44 and the speed reduction mechanism 46, the relationship in each of the above embodiments is reversed between the rotation direction of the components in the planetary mechanisms 36 and 80 and the rotation direction of the crankshaft 32 and the output part 34. Thus, the direction in which the one-way clutches 48 and 50 is laid out has to be reversed from the above embodiments, and the direction in which the first motor and the second motor are driven has to be reversed from the above embodiments.

The speed reduction mechanism 46 in each of the above embodiments can be a speed increasing mechanism or a uniform speed mechanism. In this case, for example, the number of teeth of the third gear 66A or 86B is greater than or equal to the number of teeth of the fourth gear 34B. The speed increasing ratio of the speed increasing mechanism 44 and the speed reduction ratio of the speed reduction mechanism 46 are selected so that the rotational speed of the crankshaft 32 differs from the rotational speed of the output part 34 when the second motor 40 is not operating.

The switching mechanisms 52 and 94 can be omitted from each of the above embodiments.

The planetary mechanisms 36 and 80 of each of the above embodiments can be a planetary roller mechanism. In this case, the sun gears 60A and 84A are sun rollers, the planetary gears 62 and 88 are planetary rollers, and the ring gears 56A and 86A are ring rollers.

In the planetary mechanism of each of the above embodiments, as long as the input body, the output body, and the transmission body each includes one of following members (A) to (C) and as long as the combination of the input body, the output body, and the transmission body includes all of the following members (A) to (C), any of such structures can be employed. Member (A) is a sun gear. Member (B) is a ring gear. Member (C) is a planetary gear and a carrier.

In the above embodiments, each gear can be a spur gear or a helical gear. In the above embodiments, each gear can be formed from metal or resin.

The speed increasing ratio of the speed increasing mechanism 44 and the speed reduction ratio of the speed reduction mechanism 46 can be selected so that the rotational speed of the crankshaft 32 is same as the rotational speed of the output part 34 when the second motor 40 is not operating.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle driving device. Accordingly, these directional terms, as utilized to describe the bicycle driving device should be interpreted relative to a bicycle in an upright riding position on a horizontal surface and that is equipped with the bicycle driving device. The terms “left” and “right” are used to indicate the “right” when referencing from the right side as viewed from the rear of the bicycle, and the “left” when referencing from the left side as viewed from the rear of the bicycle.

Also it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle driving device comprising:
a planetary mechanism including an input body to which rotation of a crankshaft is inputted, an output body that rotates when the input body rotates, and a transmission body that transmits rotation of the input body to the output body;
a first motor configured to rotate one of the input body and the output body;
a second motor configured to rotate the transmission body; and
an output part including a hole through which the crankshaft extends, the output part being rotatable about an axis of the crankshaft, and rotation of the output body is transmitted to the output part.

2. The bicycle driving device according to claim 1, further comprising
a speed increasing mechanism configured to increase the rotation of the crankshaft in speed and transmits the rotation to the input body.

3. The bicycle driving device according to claim 1, wherein
the speed increasing mechanism includes:
a first gear arranged on the crankshaft and rotated integrally with the crankshaft; and
a second gear arranged on the input body, rotated integrally with the input body, and engaged with the first gear.

4. The bicycle driving device according to claim 1, further comprising
a speed reduction mechanism configured to reduce the rotation of the output body in speed and transmits the rotation to the output part.

5. The bicycle driving device according to claim 4, wherein
the speed reduction mechanism includes:
a third gear arranged on the output body; and
a fourth gear arranged on the output part and engaged with the third gear.

6. The bicycle driving device according to claim 4, further comprising
a speed increasing mechanism configured to increase the rotation of the crankshaft in speed and transmits the rotation to the input body,
a speed increasing ratio of the speed increasing mechanism and a speed reduction ratio of the speed reduction mechanism being selected so that the crankshaft and the output part rotate at different speeds when the second motor is not operating.

7. The bicycle driving device according to claim 1, wherein
the second motor includes an output shaft that is coaxial with the input body.

8. The bicycle driving device according to claim 1, wherein
the second motor and the output part are located at opposite sides of the planetary mechanism in an axial direction of the crankshaft.

9. The bicycle driving device according to claim 1, further comprising
a switching mechanism configured to permit relative rotation of the crankshaft and the output part when the crankshaft rotates in a first direction and integrally rotates the crankshaft and the output part when the crankshaft rotates in a second direction.

10. The bicycle driving device according to claim 9, wherein
at least a portion of the switching mechanism is located between the crankshaft and the output part.

11. The bicycle driving device according to claim 10, wherein
the switching mechanism includes:
a roller located between an outer circumferential portion of the crankshaft and an inner circumferential portion of the output part, and
a groove formed in one of the outer circumferential portion of the crankshaft and the inner circumferential portion of the output part, the groove having a depth that increases toward the second direction.

12. The bicycle driving device according to claim 11, wherein
the crankshaft includes:
a crankshaft body; and
a support arranged on the crankshaft body and rotated integrally with the crankshaft body, the support having a larger diameter than the crankshaft body, the support being configured to contact the roller, and the roller being arranged on an outer circumferential portion of the support.

13. The bicycle driving device according to claim 12, wherein
the outer circumferential portion of the support includes the groove.

14. The bicycle driving device according to claim 1, further comprising
a housing accommodating the planetary mechanism, the first motor, the second motor, and the output part.

15. The bicycle driving device according to claim 11, wherein
the switching mechanism further includes a first biasing member, a second biasing member, and a holder that holds the roller,
the first biasing member biases the roller in the second direction with the holder; and
the second biasing member is slidably supported on the housing, and the second biasing member moves the roller relative to the crankshaft in the first direction with the holder when the crankshaft rotates in the second direction.

16. The bicycle driving device according to claim 1, wherein
the input body includes a ring gear;
the output body includes a planetary gear and a carrier, and
the transmission body includes a sun gear.

17. The bicycle driving device according claim 16, further comprising
a first one-way clutch located between the ring gear and the carrier, the first one-way clutch stopping transmitting rotation of the ring gear to the carrier when the crankshaft is rotated in the second direction.

18. The bicycle driving device according to claim 1, wherein
the input body includes a planetary gear and a carrier;
the output body includes a ring gear; and
the transmission body includes a sun gear.

19. The bicycle driving device according to claim 16, further comprising
a second one-way clutch that permits rotation of an output shaft of the second motor in one direction and restricts rotation of the output shaft in another direction.

20. The bicycle driving device according to claim 1, further comprising the crankshaft.

21. The bicycle driving device according to claim 1, further comprising a controller programmed to control the first motor and the second motor.
